(19) United States
(12) Patent Application Publication
(10) Pub. No.: US 2006/0058178 A1
(43) Pub. Date: Mar. 16, 2006

(54) Aromatic compounds containing nitrogen and p- functionalized amines, the production thereof and their use in catalytic reactions

(76) Inventors: Rhett Kempe, Berlin (DE); Thomas Schareina, Cammin (DE); Axel Monsees, Frankfurt (DE); Thomas Riermeier, Florsheim (DE)

Correspondence Address: Michael A Sanzo;Fitch Even Tabin & Flannery, 1801 K Street NW, Suite 401L, Washington, DC, 20006-1201, US

(21) Appl. No.: 10/495,969

(22) PCT Filed: Nov. 21, 2002
(86) PCT No.: PCT/EP02/13048

§ 371 Date: Jun. 30, 2005

(30) Foreign Application Priority Data
Nov. 23, 2001 (DE) 101 57 358.8

(51) Int. Cl. B01J 31/00; C07F 9/02

(52) U.S. Cl. 502/152; 502/155; 544/243; 546/22; 544/337; 564/12

(57) ABSTRACT

The present invention is directed to P-functionalized amines of nitrogen-containing compounds and to catalysts prepared by combining these amines with transition metals. The catalysts are especially useful for refining haloaromatics.

The present invention concerns novel ligands for transition metals, their production and their use in catalytic reactions, especially for refining haloaromatics.

Haloaromatics, especially chlorine aromatics, are versatile intermediates of the chemical industry, which are used as pre-products for the production of agro-intermediates, pharmaceuticals, dyes, etc. Vinyl halides are also important intermediates that are used as starting materials for polymers and for the production of the aforementioned products.

Commonly used catalysts for the functionalisation of haloaromatics or vinyl halides to aromatic olefins or dienes (Heck reaction, Stille reaction), biaryls (Suzuki reaction), alkynes (Sonogashira reaction), carboxylic acid derivatives (Heck carbonylation), amines (Buchwald-Hartwig reaction) are palladium and nickel catalysts. Palladium catalysts are generally advantageous as far as the breadth of applicability of coupling substrates and in some cases catalyst activity is concerned, whilst nickel catalysts offer advantages in the area of the reaction of chlorine aromatics and vinyl chlorides and in terms of the cost of the metal.

Palladium and nickel catalysts that are used in the activation and further refining of haloaromatics are both palladium(II) and/or nickel(II) and palladium(0) and/or nickel(0) complexes, although it is known that palladium(0) and nickel(0) compounds are the actual catalysts for the reaction. In particular, coordinately unsaturated 14- and 16-electron palladium(0) and nickel(0) complexes, which are stabilised with donor ligands such as phosphanes, are formulated as active species according to instructions given in the literature.

Where iodides are used as educts in coupling reactions, it is also possible to dispense with the use of phosphane ligands. However, aryl and vinyl iodides are very expensive starting compounds and, in addition, stoichiometric amounts of iodine salt waste are obtained during their reaction. If less expensive educts, such as aryl bromides or aryl chlorides, are used in the Heck reaction, stabilising and activating ligands have to be added in order for the educts to be reacted in a catalytically effective manner.

The catalyst systems described for olefinations, alkynylations, carbonylations, arylations, aminations and similar reactions frequently have satisfactory catalytic turnover numbers (TON) only with uneconomic starting materials such as iodine aromatics and activated bromine aromatics. Otherwise, in the case of deactivated bromine aromatics and especially chlorine aromatics, large amounts of catalyst—usually over 1 mol %—generally have to be added in order to achieve technically useable yields (>90%). In addition, due to the complexity of the reaction mixtures, simple catalyst recycling is not possible, which means that recycling the catalyst also gives rise to high costs which generally stand in the way of implementation in industry. Furthermore, especially in the production of active ingredients or of pre-products for active ingredients, it is undesirable to work with large amounts of catalyst, since otherwise catalyst residues remain in the product in this case.

More recent active catalyst systems are based on cyclopalladated phosphanes (W. A. Herrmann, C. Broβimer, K. Öfele, C.-P. Reisinger, T. Priermeier, M. Beller, H. Fischer, Angew. Chem. 1995, 107, 1989; Angew. Chem. Int Ed. Engl. 1995, 34, 1844) or mixtures of sterically exacting aryl phosphanes (J. P. Wolfe, S. L. Buchwald, Angew. Chem. 1999, 111, 2570; Angew. Chem. Int Ed. Engl. 1999, 38, 2413) or tri-tert.-butyl phosphane (A. F. Littke, G. C. Fu, Angew. Chem. 1998, 110, 3586; Angew. Chem. Int Ed. Engl. 1998, 37, 3387) with palladium salts or palladium complexes.

However, inexpensive chlorine aromatics generally cannot be activated in a technically satisfactory manner even with these catalysts, in other words catalyst productivities (TON) are <10000 and catalyst activities (TOF) are <1000 h⁻¹. This means that comparatively large amounts of catalyst have to be used to obtain high yields, a practice that is associated with high costs. For example, at current noble metal prices, using 1 mol % palladium catalyst, the catalyst costs for producing one kilogram of an organic intermediate with a molecular weight of 200 are over 100 US$, which illustrates the need to improve catalyst productivity. For that reason, despite all the further developments in catalysts over recent years, few industrial arylation, carbonylation, olefination, etc., reactions of chlorine aromatics have emerged to date.

For the reasons stated, the object underlying the present invention was to satisfy the great need for novel, more productive catalyst systems which have simple ligands and exhibit none of the disadvantages of the known catalytic processes, which are suitable for large-scale use and which convert inexpensive chlorine and bromine aromatics and corresponding vinyl compounds to their respective coupling products with high yield, catalyst productivity and purity.

This object is achieved according to the invention by the development of novel P-functionalised amines of nitrogen-containing aromatics, in particular by P-functionalised aminopyridines, having the general formula
R1(R²)P—N(R′)R″ (I)
wherein
R¹ and R² mutually independently stand for a radical selected from the group consisting of C₁-C₂₄ alkyl, C₃-C₈ cycloalkyl and aromatic radicals having 5 to 14 C-atoms, in particular phenyl, naphthyl or fluorenyl, wherein at least one, preferably two to three, of the C atoms can also be replaced by a heteroatom mutually independently selected from the group consisting of N, O and S, and wherein the alkyl and cycloalkyl radicals can be saturated or unsaturated, branched or unbranched. The cyclic aliphatic or aromatic radicals are preferably five- or six-membered rings.

The aforementioned radicals can themselves each be mono- or polysubstituted.

These substituents can mutually independently be hydrogen, C₁-C₂₀ alkyl, C₂-C₂₀ alkenyl, C₁-C₁₀ haloalkyl, C₃-C₈ cycloalkyl, C₂-C₉ heteroalkyl, aromatic radicals having 6 to 10 C atoms, in particular phenyl, naphthyl or fluorenyl, wherein 1, preferably up to 4, of the C atoms can also be replaced by a heteroatom, mutually independently selected from the group N, O and S, C₁-C₁₀ alkoxy, preferably OMe, C₁-C₉ trihalomethylalkyl, preferably trifluoromethyl and trichloromethyl, halo, especially fluoro and chloro, nitro, hydroxy, trifluoromethyl sulfonato, oxo, amino, C₁-C₈ substituted amino in the forms NH-alkyl-C₁-C₈, NH-aryl-C₅-C₆, N-alkyl₂-C₁-C₈, N-aryl₂-C₅-C₆, N-alkyl₃-C₁-C₈⁺, N-aryl₃-C₅-C₆⁺, NH—CO-alkyl-C₁-C₈, NH—CO-aryl-C₅-C₆, cyano, carboxylato in the forms COOH and COOQ wherein Q represents either a monovalent cation or C₁-C₈ alkyl, C₁-C₆ acyloxy, sulfinato, sulfonato in the forms SO₃H and SO₃Q, wherein Q represents either a monovalent cation, C₁-C₈ alkyl or C₆ aryl, phosphato in the forms PO₃H₂, PO₃HQ and PO₃Q₂, wherein Q represents either a monovalent cation, C₁-C₈ alkyl or C₆ aryl, tri-C₁-C₆ alkyl silyl, especially SiMe₃,

wherein

R¹ and R² can also be bridged together, preferably forming a four- to eight-membered cyclic compound, which can be saturated, unsaturated or aromatic.

R¹ and R² are preferably mutually independently a radical selected from the group consisting of phenyl, cyclohexyl, alkyl, 2-alkylphenyl, 3-alkylphenyl, 4-alkylphenyl, 2,6-dialkylphenyl, 3,5-dialkylphenyl, 3,4,5-trialkylphenyl, 2-alkoxyphenyl, 3-alkoxyphenyl, 4-alkoxyphenyl, 2,6-dialkoxyphenyl, 3,5-dialkoxyphenyl, 3,4,5-trialkoxyphenyl, 3,5-dialkyl-4-alkoxyphenyl, 4-dialkylamino, wherein the aforementioned alkyl and alkoxy groups can preferably each mutually independently contain 1 to 6 carbon atoms, 3,5-trifluoromethyl, 4-trifluoromethyl, 2-sulfonyl, 3-sulfonyl and 4-sulfonyl.

R¹ and R² are particularly preferably mutually independently a radical selected from the group consisting of phenyl, cyclohexyl and tert.-butyl.

In a preferred embodiment the radicals R¹ and R² are identical.

R′ is an aromatic radical containing at least one N atom and having 4 to 13 C atoms, which is bound to the nitrogen atom according to formula I in the 2-position relative to the at least one aromatic N atom. One or more, preferably up to three, of the cited aromatic C atoms can also be replaced here by a further heteroatom, mutually independently selected from the group consisting of N, O and S.

The aromatic radical having 4 to 13 C atoms is preferably pyrimidyl, pyrazinyl, pyridyl or quinolinyl.

R″ is trimethylsilyl or an aromatic radical having 5 to 14 C atoms, wherein one or more, preferably up to four, C atoms can be replaced by a heteroatom mutually independently selected from the group consisting of N, O and S.

The aromatic radical is preferably pyrimidyl, pyrazinyl, pyridyl, quinolinyl, phenyl, fluorenyl or naphthyl.

In a preferred embodiment R″ is the same radical as R′, the radical preferably being bound to the N atom according to formula (I) in the same way as R′, in other words in the 2-position relative to the aromatic N atom.

The radicals listed for R′ and R″ can furthermore mutually independently display at least one, particularly preferably up to three, substituents in addition to hydrogen atoms, which can mutually independently be selected from the group consisting of C₁ to C₈ alkyl, O-alkyl(C₁-C₈), OH, OCO-alkyl(C₁-C₈), O-phenyl, phenyl, aryl, fluorine, NO₂, Si-alkyl(C₁-C₈)₃, CN, COOH, CHO, SO₃H, NH₂, NH-alkyl(C₁-C₈), N-alkyl(C₁-C₈)₂, NH-aryl, N-aryl₂, P(alkyl(C₁-C₈))₂, P(aryl)₂, SO₂-alkyl(C₁-C₆), SO-alkyl(C₁-C₆), CF₃, NHCO-alkyl(C₁-C₄), COO-alkyl(C₁-C₈), CONH₂, CO-alkyl(C₁-C₈), NHCHO, NHCOO-alkyl(C₁-C₄), CO-phenyl, COO-phenyl, CH═CH—CO₂-alkyl(C₁-C₈), CH═CHCOOH, PO(phenyl)₂, PO(alkyl(C₁-C₄))₂, PO₃H₂, PO(O-alkyl(C₁-C₆))₂, SO₃(alkyl(C₁-C₄)), wherein aryl represents an aromatic having 5 to 14 ring-carbon atoms, wherein one or more ring-carbon atoms can be replaced by nitrogen, oxygen and/or sulfur atoms and the alkyl radicals can be branched, unbranched and/or cyclic, saturated or unsaturated.

Heteroaromatic radicals can for example be at least five-membered rings containing 1 to 13 ring-carbon atoms, which contain up to 4 nitrogen atoms and/or up to 2 oxygen or sulfur atoms. Preferred heteroaromatic aryl radicals contain one or two nitrogen or one oxygen or one sulfur or one nitrogen and one oxygen or sulfur heteroatom.

The at least one substituent for R′ and R″ is preferably a group selected from C₁-C₈-alkyl, O-alkyl(C₁-C₈), OH, OCO-alkyl(C₁-C₈), O-phenyl, phenyl, aryl, fluorine, Si-alkyl(C₁-C₈)₃, CN, COOH, SO₃H, SO₂-alkyl(C₁-C₆), SO-alkyl(C₁-C₆), CF₃, COO-alkyl(C₁-C₈), CO-alkyl(C₁-C₈), CO-phenyl, COO-phenyl and SO₃(alkyl(C₁-C₄)).

The at least one substituent for R¹, R², R′ and R″, in addition to H atoms, is mutually independently in each case particularly preferably a radical selected from the group consisting of C₁ to C₆ alkyl, O-alkyl(C₁-C₆), OH and N-pyridyl₂.

The substituted radical R′ is particularly preferably a radical selected from the group consisting of 3-methylpyridyl, 4-methylpyridyl, 6-methylpyridyl, 4,6-dimethylpyridyl, 6-methoxypyridyl, pyridyl, pyrimidyl, pyrazinyl, 4-methyl quinolinyl or Py₂(o-P) (see Table 1), wherein R′ is bound in the 2-position to the N atom according to formula (I).

The present invention also provides a process for the production of P-functionalised N-containing aromatic amine ligands, wherein in the presence of a strong base, a compound having the formula NHR′R″ is reacted with a compound having the formula R¹(R²)PX, wherein R¹, R², R′ and R″ have the same meaning as in formula (I) and wherein X preferably stands for a halogen atom, in particular for chlorine or bromine. The strong base is preferably an organometallic reagent, particularly preferably butyl lithium, sec.-butyl lithium, tert.-butyl lithium or lithium diisopropylamine. The reaction can be performed in an organic solvent, for example hexane, under anaerobic conditions.

Amines having the formula NHR′R″ and in particular a large number of bipyridyl amines, 2-aminopyridines or related N-heterocyclic amines, which can be used as starting compounds for the production of ligands according to the invention, can be prepared here by means of palladium-catalysed aryl aminations starting from primary amines in the classical way according to the scheme below (S. Wagaw, S. L. Buchwald, J. Org. Chem. 1996, 61, 7240; J. Stilberg et al., J. Organomet. Chem. 2001, 622, 6-18; J. F. Hartwig, Synleft 1996, 329):
R′NH₂+R″X→R′NHR″ or
R″NH₂+R′X→R′NHR″,
wherein X stands for a halogen atom, in particular for chlorine, bromine or iodine, or possibly for a protected oxygen atom, for example OTf.

In particular, one of the following amines, selected from the group consisting of N-(4-methylpyrid-2-yl)-N-(pyrimid-2-yl) amine, N-(4,6-dimethylpyrid-2-yl)-N-(6-methoxypyrid-2-yl) amine, N,N-bis(pyrazinyl) amine, N,N,N′-tris(pyrid-2-yl)-o-phenylene diamine, can be used as a starting compound for the ligands according to the invention. These novel amines are also provided by the present invention.

The novel ligands are used according to the invention as catalysts in combination with transition metal complexes or transition metal salts of subgroup VIII of the periodic table of elements, such as e.g. palladium, nickel, platinum, rhodium, iridium, ruthenium, cobalt.

The ligands according to the invention can generally be added in situ to appropriate transition metal precursor compounds and used in this way for catalytic applications.

The present invention therefore also provides a coordination compound, comprising a P-functionalised amine according to the invention of an N-containing aromatic and a metal from group VIII. The transition metal here is preferably part of a five-membered ring and one phosphorus atom and two nitrogen atoms are particularly preferably also part of this five-membered ring.

By reason of the formation of a five-membered ring, in place of the six-membered ring that is normally to be found, the complex is especially well suited to the catalysis of reactions with substrates carrying substituents that are sterically particularly exacting.

The present invention also provides a process for the production of the coordination compounds according to the invention, characterised in that ligands according to the invention, which are preferably obtained as described above, are reacted with a complex and/or salt of a transition metal from group VIII of the periodic table. The group VIII transition metal is preferably Pd or Ni.

Examples of palladium components that can be used with the ligands according to the invention include: palladium(II) acetate, palladium(II) chloride, palladium(II) bromide, lithium tetrachloropalladate(II), palladium(II) acetyl acetonate, palladium(0) dibenzylidene acetone complexes, in particular dipalladium tris-dibenzylidene acetone, palladium (1,5-cyclooctadiene) chloride, palladium(0) tetrakis (triphenyl phosphane), palladium(0) bis(tri-o-tolyl phosphane), palladium(II) propionate, palladium(II) bis(triphenyl phosphane) dichloride, palladium(0) diallyl ether complexes, palladium(II) nitrate, palladium(II) chloride bis(acetonitrile), palladium(II) chloride bis(benzonitrile) and other palladium(0) and palladium(II) complexes.

Examples of nickel precursors that can be used include bis(1,5-cyclooctadiene) nickel(0), bis(triphenyl phosphine) nickel(II) bromide, nickel(II) acetate, nickel(II) chloride, nickel(II) acetylacetonate, nickel(II) bromide, nickel(0) tetrakis (triphenyl phosphane), nickel(II) iodide, nickel(II) trifluoracetylacetonate or nickel bromide dimethoxyethane adduct.

Alternatively, production of the complex can be made shorter by producing it starting directly from the ligand precursors, either in a batch process or, particularly preferably, in situ, without the need for a stepwise procedure and/or purification of the ligands according to the invention.

In this way, using di-tert.-butyl chlorophosphane, for example, production of the complex starting from the ligand precursors can be performed in situ by setting out all reaction partners together at the start.

If diphenyl and dicyclohexyl chlorophosphane are used, the complex is preferably produced in a batch process starting from the ligand precursors.

The complexes that are formed are particularly preferably also examined for activity without prior purification, by introducing the substrates for the reaction to be performed directly into the reaction solution obtained from production of the complexes.

In this way the entire process, starting from the ligand precursors through to the activity test for the complexes obtained, can therefore be performed in a batch process, in other words in a one-pot process. This is particularly advantageous since in this way a large number of complexes can efficiently be tested in parallel for catalytic activity on a large scale, and furthermore a miniaturisation of the process becomes possible. This ultimately leads to huge time and cost savings.

A particular advantage of the ligands and complexes according to the invention is therefore that they can be prepared efficiently and diversely by parallel synthesis under anaerobic conditions.

The present invention also provides a process for the activation of haloaromatics, characterised in that a ligand according to the invention, in the presence of a metal from group VIII of the periodic table and/or a coordination compound according to the invention, preferably in the presence of a base, such as e.g. K₂CO₃, NaOtBu, K₃PO₄ or Na₂CO₃, is used as catalyst.

The ligands produced according to the invention can thus be used as the ligand component for the catalytic production of arylated olefins (Heck reactions), biaryls (Suzuki reactions), α-aryl ketones and amines from aryl halides or vinyl halides and/or for the production of dienes, benzoic acid derivatives, acrylic acid derivatives, aryl alkanes, alkynes and amines. In addition, other transition metal-catalysed reactions such as palladium- and nickel-catalysed carbonylations of aryl halides, alkynylations with alkynes (Sonogashira couplings), cross-couplings with organometallic reagents (zinc reagents, tin reagents, etc.) can also be performed with the novel catalyst systems.

The compounds produced in this way can be used inter alia as UV absorbers, as intermediates for pharmaceuticals and agrochemicals, as ligand precursors for metallocene catalysts, as perfumes, active ingredients and building blocks for polymers.

In catalytic applications the phosphane ligand is generally used in excess relative to the transition metal. The ratio of transition metal to ligand is preferably 1:1 to 1:1000. Ratios of transition metal to ligand of 1:1 to 1:100 are particularly preferred. The exact ratio of transition metal to ligand to be used depends on the specific application and also on the amount of catalyst used.

According to the invention the transition metal concentration is preferably between 5 mol % and 0.001 mol %, particularly preferably between 1 mol % and 0.01 mol %.

According to the invention the catalysts according to the invention are preferably used at temperatures of 0 to 200° C.

A particular advantage of the ligands according to the invention is the high activity that the ligands induce in the activation of inexpensive yet inert chlorine aromatics. As shown in the comparative examples, palladium catalysts with the novel ligands surpass the best catalyst systems known to date.

For example, some of the most active ligands known until now in the palladium complex- and/or nickel complex-catalysed Suzuki coupling are TtBP (A. F. Littke, G. C. Fu, Angew. Chem. Int. Ed. 1998, 37, 3387-3388; A. F. Littke, C. Dai, G. C. Fu, J. Am. Chem. Soc. 2000, 122, 4020-28) and BINAP and BDPP (Wagaw and Buchwal, J. Org. Chem. 1996, 61, 724041; J. F. Hartwig, Synlett 1996, 329-340; Silberg et al., J. Organomet. Chem. 2001, 622, 6-18; Schareina et al. Eur. J. Inorg. Chem. 2001). Their activity is reproducibly surpassed by the catalyst systems according to the invention, as can also be seen from the tables.

### FIGURES

FIG. 1 shows by way of example the production of a ligand according to the invention and the subsequent production of the corresponding complex with a group VIII transition metal.

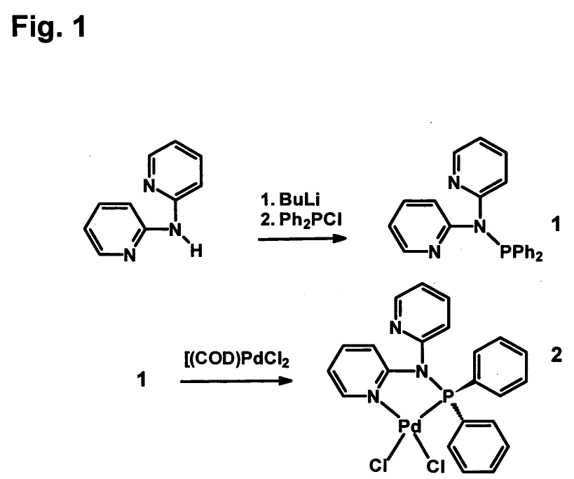

FIG. 2 illustrates the molecular structure of the complex obtainable by the reaction steps shown in FIG. 1. The structure was determined by X-ray structural analysis. Selected bond lengths and angles [Å, °]: N1 P1 1.702(5), N2 Pdl 2.053(5), P1 Pd1 2.1951(15), CI1 Pd1 2.3731(14), CI2 Pd1 2.303(2), N2 Pd1 P1 83.15(14), P1 Pd1 CI2 89.52(6), N2 Pd1 CI1 95.00(14), CI2 Pd1 CI1 92.36(6). Averages^{[xyz]} for the following bond parameters: Pd—N 2.074(12) A, Pd—P 2.206(5) A, Pd—CI Å 2.33(1) and N—Pd—P 84.7(5)°.

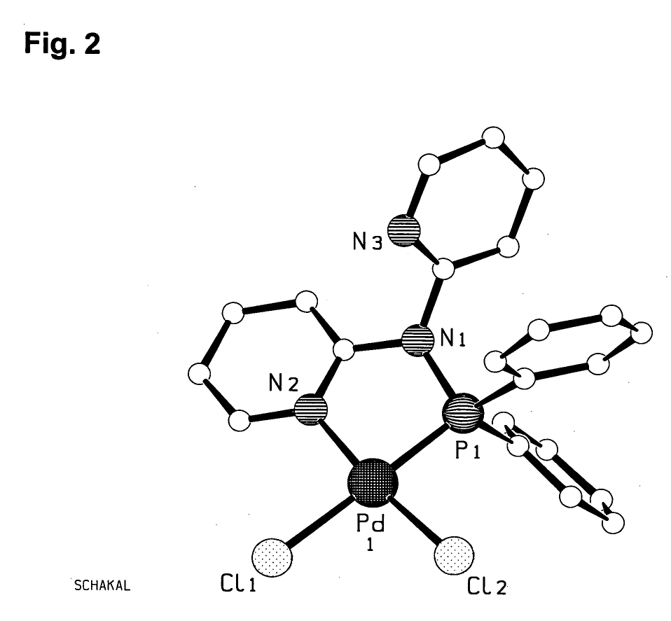

### EMBODIMENT EXAMPLES

General information: materials and mode of operation:

The commercially available materials were used without any further purification. Materials sensitive to air or water were handled in dried Schlenk flasks with strict exclusion of air and water or in a glove box (Braun, Labmaster 130). Solvents (Aldrich) and NMR solvents (Cambridge Isotope Laboratories, min. 99 atom % D) were distilled from sodium tetraethyl aluminate or molecular sieve (CH₂Cl₂, CD₂Cl₂).

TABLE 1
Overview of and abbreviations for the ligands
used in the embodiment examples.

| RR′R″ = R₂P—N(R′)R″ | with R: | |
|---|---|---|
| P = phenyl | C = cyclohexyl | B = tert.-butyl |
| | with R′ or R″: | |
| 3M = 3-methylpyrid-2-yl | 4M = 4-methylpyrid-2-yl | 6M = 6-methylpyrid-2-yl |
| 46M = 4,6-dimethylpyrid-2-yl | Mx = 6-methoxypyrid-2-yl | Pa = pyrazinyl |
| Pm = 2-pyrimidyl | Py = 2-pyridyl | Si = trimethylsilyl |
| L = 4-methyl quinolin-2-yl | Py₂(o-P) | |
| 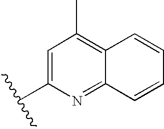 | 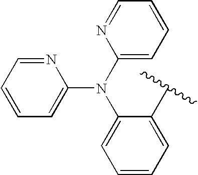 | |

In order to obtain a comparison with regard to reactivity, the following ligands, which represent the closest prior art, were used: TtBP=tri(t-butyl) phosphane, BINAP=rac.-bis(diphenyl phosphino)-1,1′-binaphthyl, BDPP=1,3-bis(diphenyl phosphino)propane; DtBPCl=di-tert.-butyl phosphine chloride;

TABLE 2
Abbreviations for and overview of the metal salts used
according to the invention.

| | |
|---|---|
| Pd₂(dba)₃ | dipalladium tris-dibenzylidene |
| | acetone. |
| Pd(OAc)₂ | palladium acetate. |
| PdCl₂(cod) | palladium(1,5-cyclooctadiene) |
| | chloride. |
| Ni(cod)₂ | nickel bis-(1,5-cyclooctadiene). |
| NiBr₂(dme) | nickel bromide dimethoxyethane |
| | adduct. |

### Example 1

### Provision and Preparation of Precursors for the Production of the Ligands According to the Invention

The amines listed below were used as precursors for the production of the ligands produced in the embodiment examples.

2,2′-Dipyridyl Amine, Abbreviation—PyPy: Commercially Available

TABLE 3
Already known amines

| Name | Abbreviation |
|---|---|
| N-(pyrid-2-yl)-N-(3-methylpyrid-2-yl) amine | -3MPy¹ |
| N-(pyrid-2-yl)-N-(6-methylpyrid-2-yl) amine | -6MPy¹ |
| N-(6-methylpyrid-2-yl)-N-(4-methyl quinolin-2-yl) amine | -6ML¹ |
| N,N-bis(6-methylpyrid-2-yl) amine | -6M6M¹ |
| N,N-bis(pyrimid-2-yl) amine | -PmPm² |

¹J. Silberg, T. Schareina, R. Kempe, K. Wurst, M. R. Buchmeiser, J. Organomet. Chem., 2001, 622, 6.
²M. R. Buchmeiser, T. Schareina, R. Kempe, K. Wurst, J. Organomet. Chem., being printed.

TABLE 4
New precursors for ligands according to the invention:

| Name | Abbreviation |
|---|---|
| N-(4-methylpyrid-2-yl)-N-(pyrimid-2-yl) amine | -4MPm |
| N-(4,6-dimethylpyrid-2-yl)-N-(6-methoxypyrid-2-yl) amine | -46MMx |
| N,N-bis(pyrazinyl) amine | -PaPa |
| N,N,N'-tris(pyrid-2-yl)-o-phenylene diamine | -Py₂(o-P)Py |

For the ligands with only one heterocyclic substituent (e.g. PSiPy, CSiPm, etc.) the corresponding commercially available amines were used as starting material.

Trimethylsilyl-substituted compounds were produced from the amine in THF by addition of 1 equivalent of n-BuLi solution in hexane at −77° C., heating to room temperature, addition of 1 equivalent of pure (CH₃)₃SiCl and stirring for 24 hours at room temperature. Other modifications with phosphines were produced in a similar way.

The phosphanyl radicals diphenyl chlorophosphane, dicyclohexyl chlorophosphane and di-tert.-butyl chlorophosphane used according to the invention are all commercially available.

The metal precursors were commercially available or were produced by instructions in the literature.
a) Production of Precursor—4MPm 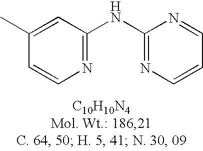
4.33 g (40 mmol) 2-amino-4-picoline
4.58 g (40 mmol) 2-chloropyrimidine
80 mg (0.2 mmol) bis-diphenyl phosphinopropane
88 mg (0.2 mmol Pd) dipalladium tris-(dibenzylidene acetone)
4.22 g (44 mmol) sodium tert.-butylate

Combined under Ar in a 100 ml Schlenk flask. The mixture is heated to 90° C. without solvent with stirring for 24 hours. Melts to a dark brown melt with no perceptible solids components. Working up: addition of dichloromethane (dissolves completely), then washed with water and saturated sodium chloride solution, dried over sodium sulfate and evaporated. Dark reddish brown tarry mass. The raw product is taken up with dichloromethane on silica gel, introduced into a Soxhiet thimble and extracted with petroleum ether (boiling range 80-100° C.)/toluene, v/v approx. 3:1, for 3 days. The deposit that appears after cooling is filtered through a P4 sintered-glass filter and washed with n-hexane and n-pentane. Weighed out quantity 2.12 g, 28% of theoretical, NMR pure.

Elemental analysis, calculated for C₁₀H₁₀N₄ (M_{w}=186.21 g/mol): C, 64.50; H, 5.41; N, 30.09. Found: C, 64.47; H, 5.30; N, 30.31.

¹H-NMR (CDCl₃): 9.16 (bs, 1H, NH), 8.55 (m, 2H), 8.24 (m, 2H), 6.77 (m, 2H), 2.38 (s, 3H, CH₃)

¹³C-NMR (CDCl₃): 159.7, 158.4, 153.2, 150.1, 147.5, 136.1, 119.3, 113.7, 113.5, 22.1.
b) Production of Precursor—46MMx 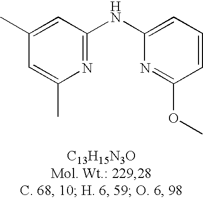
3.00 g (24.6 mmol) 2-amino-4,6-dimethylpyridine
2.92 ml (3.53 g, 24.6 mmol) 2-chloro-6-methoxypyridine
0.082 g (0.2 mmol) bis-diphenyl phosphinopropane
0.090 g (0.2 mmol Pd) dipalladium tris-(dibenzylidene acetone)
2.88 g (30 mmol) sodium tert.-butylate
approx. 20 ml toluene

The mixture is heated to 75° C. in an oil bath with stirring, and the temperature raised after 2 hours to 80° C. After a further 30 minutes a deposit is precipitated out. Thin-layer chromatography analysis (solvent dichloromethane, mobile solvent PE/ethyl acetate 1:1) shows that the reaction is still not completed after 4 hours, so stirring is continued for a further 12 hours at 80° C. Working up is performed with dichloromethane and water, the organic phase is dried over sodium sulfate and evaporated to a brown oil, which solidifies when left to stand overnight. The total amount is recrystallised out of 20 ml n-hexane. After crystallising out, large crystal conglomerates are obtained, which could not be removed from the flask. The solvent is decanted off, the solid rinsed with n-hexane, dissolved in dichloromethane, filtered, evaporated. The product is melted in an oil pump vacuum until no further solvent gases emerge, and allowed to stand. Reddish brown oil, from which crystal clusters grow rapidly. Weighed out quantity 4.81 g (85% of theoretical). Analyses OK.

Elemental analysis, calculated for C₁₃H₁₅N₃O (M_{w}=229.28 g/mol): C, 68.10; H, 6.59; N, 18.33. Found: C, 68.24; H, 6.64; N, 18.08. ¹H(C₆D₆): 7.347 (bs, 1H, NH); 7.12 (t, 1H); 6.98 (d, 1H); 6.92 (s, 1H); 6.30 (d, 1H); 6.26 (s, 1H); 3.77 (s, 3H, —O—CH₃); 2.38 (s, 3H); 1.92 (s, 3H). ¹³C(C₆D₆): 163.8; 156.8; 154.4; 153.3; 148.7; 140.5; 117.1; 109.5; 103.3; 102.2; 53.3; 24.5; 21.2.
c) Production of Precursor—PaPa 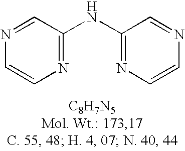
0.951 g (10 mmol) aminopyrazine
0.89 ml (1.145 g, 10 mmol) chloropyrazine
41 mg (0.1 mmol) bis-diphenyl phosphinopropane
46 mg (0.1 mmol Pd) dipalladium tris-(dibenzylidene acetone)
1.15 g sodium tert.-butylate

Weigh into a Schlenk flask under argon, then add approx. 20 ml absolute toluene, stir at 80° C. in an oil bath. The contents of the Schlenk flask soon turn yellow, deposit. Working up after 4 hours. The reaction mixture is poured onto a sintered-glass filter and the Schlenk flask rinsed with ether. The solid on the sintered-glass filter is washed with ether, water and again with ether. Recrystallisation from water, with hot filtration. After drying in a desiccator over KOH, 1.03 g of fine orange-yellow needles are obtained (60% of theoretical).

Elemental analysis, calculated for C₈H₇N₅ (M_{w}=173.17 g/mol): C, 55.48; H, 4.07; N, 40.44. Found: C, 55.86; H, 4.19; N, 40.37. ¹H (DMSO-d₆): 9.52 (bs, 1H, NH); 8.16 (s, 2H); 7.43 (s, 2H); 7.30 (s, 2H). ¹³C (DMSO-d₆): 150.6; 142.1; 136.9; 135.6.
d) Production of Precursor—Py₂(o-P)Py 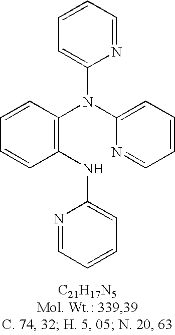
1.08 g (10 mmol) o-phenylene diamine
40 mg (0.1 mmol) bis-diphenyl phosphinopropane
44 mg (0.1 mmol Pd) dipalladium tris-(dibenzylidene acetone)
3.17 g (33 mmol) sodium tert.-butylate
2.93 ml (4.75 g, 30 mmol) 2-bromopyridine

Add 20 ml diethylene glycol dimethyl ether, heat to 110° C., stir. Adjusted to 125° C. after 2 days, reaction terminated after a total of 6 days and the mixture worked up. The solvent is removed by condensation in a dry-ice-cooled flask. Water and dichloromethane are added until both phases are clear. The mixture is transferred to a separating funnel. The organic phase is washed once with water and once with saturated sodium chloride solution, dried over sodium sulfate, evaporated. Purification is performed by column chromatography on silica gel 60 from Merck, mobile solvent is ethyl acetate. The target product is eluted after the intermediate N,N′-bis(pyrid-2-yl)-o-phenylene diamine. After removal of the solvents, the weighed-out quantity is 1.70 g (50% of theoretical).

Elemental analysis, calculated for C₂₁H₁₇N₅ (M_{w}=339.39 g/mol): C, 74.32; H, 5.05; N, 20.63. Found: C, 74.33; H, 4.91; N, 20.76. ¹H (CDCl₃): 8.22 (dd, 2H); 8.10 (d, 1H); 8.03 (m, 1H); 7.46 (m, 2H); 7.38 (bs, 1H), NH); 7.31 (m, 2H); 7.23 (dd, 1H); 7.03 (m, 1H); 6.91 (d, 2H); 6.82 (m, 2H); 6.59 (m, 2H). ¹³C, 157.3; 155.4; 148.3; 137.8; 137.4; 130.3; 128.3; 123.3; 121.6; 118.1; 115.8; 114.8; 110.1.

### Example 2

### Stepwise Synthesis of Ligand and Complex Using Compound 1 and Complex 2

a) Production of the Ligand Ph₂P—N(pyridyl)₂

1.6 ml 2.5M (4 mmol) n-BuLi in hexane are added to 0.68 g (4 mmol) bipyrid-2-yl amine in 10 ml ether under argon at −77° C. After 1 hour 0.72 ml (0.882 g, 4 mmol) chlorodiphenyl phosphine in 4 ml ether are added dropwise. During the dropwise addition the contents of the Schlenk flask turn bright yellow. After stirring for 48 hours at room temperature the solution is transferred to another Schlenk flask by filtration and then rewashed twice with a mixture of 10 ml ether and 10 ml THF. The solvent is removed by condensation in vacuo in a flask cooled with dry ice, the solid is then dried under 1 mbar and at room temperature. Weighed out quantity 1.42 g (quantitative) NMR-pure substance. A sample is dissolved in diethyl ether and covered with a layer of n-hexane. After some time colourless crystals are precipitated out, which are examined by X-ray structural analysis.

Elemental analysis: C₂₂H₁₈N₃P; molecular weight: 355.37 g-mol⁻¹; calculated: C. 74.35; H. 5.11; N. 11.82; found: C, 74.50; H, 5.31; N, 11.68. ¹H(C₆D₆): 8.16 (m, 2H); 7.73 (m, 4H); 6.97 (m, 6H); 6.57 (d, 2H); 6.33 (ddd, 2H). ¹³C(C₆D₆): 158.35; 158.29; 148.81; 138.74; 138.54; 136.97; 136.07; 136.06; 133.76; 133.55; 132.04; 128.77; 128.53; 128.11; 118.37; 118.26. ³¹p (C₆D₆): 69.37.

b) Production of the Pd Complex from Ph₂P—N(pyridyl)₂

4 ml of dry dichloromethane are added to 0.071 g (0.25 mmol) (COD)PdCl₂ and 0.089 g Ph₂P—N(pyridyl)₂ in a Schlenk flask under argon. The solids dissolve very quickly. By covering with a layer of 6 ml diethyl ether, pale yellow crystals are obtained after approximately 1 week. Isolation by filtration, washed with 4 ml ether, dried in an oil pump vacuum. Yellow crystals, 0.10 g (75% of theoretical).

Elemental analysis: C₂₂H₁₈Cl₂N₃PPd; molecular weight: 532.70 g·mol¹; calculated: C. 49,60; H. 3, 41; N. 7, 89; found: C, 49.29; H, 3.51, N, 7.81. ¹H (CD₂Cl₂): 9.43 (m, 1H); 8.24 (m, 1H); 7.88 (m, 5H); 7.66 (m, 1H); 7.50 (m, 4H); 7.37 (m, 5H); 7.08 (m, 1H); 7.02 (m, 1H); 6.70 (m, 1H); 6.54 (m, 1H). ³C (CD₂Cl₂): 150.4; 150.1; 149.1; 140.2; 138.5; 133.4; 133.3; 132.2; 127.8; 127.7; 125.9; 125.3; 122.8; 121.7; 121.7; 120.8; 118.0. ³¹p (CD₂Cl₂): 99.2.

### Example 3

### Performance of selected Suzuki Reactions

All solvents are dried by standard methods, distilled from Na benzophenone ketyl and sodium tetraethylate and stored under argon. Commercially available starting materials were used without any further purification, liquids stored under argon. All operations were performed under argon in Schlenk flasks.

Stock solutions of the substrates, ligands and metal precursors are produced in the stated solvents, the concentration for substrates (chlorine aromatics and phenyl boronic acid) was 1 mol l⁻¹, for ligands and metal precursors c=0.025 mol l⁻¹.

In the case of the diphenyl- and dicyclohexyl-substituted phosphanyl radicals the ligands were produced as follows: the amine (1 mmol) is metalated with 0.4 ml of a 2.5M solution of n-BuLi in hexane at −77° C., held for 30 minutes at −77° C., then allowed to heat up to room temperature, then one equivalent of chlorodiphenyl phosphane or chlorodicyclohexyl phosphane is added and the mixture stirred for at least 24 hours at room temperature. The solution is topped up with inert solvent so that the concentration of the ligand is 0.025 mol l⁻¹.

Production of the di(tert.-butyl)phosphane-substituted ligands was performed in situ, by heating 1 equivalent each of amine, chlorodi(tert.-butyl)phosphane and metal precursor as stock solutions together with the base in a Schlenk reaction vessel for 1 hour at 60° C., then the substrates are added at room temperature.

The screening reactions were performed as follows: all reactions were performed in the parallel equipment under Ar. The base was dried in advance in vacuo at 130° C. for 24 hours, and the quantities weighed out in a vacuum box. Stock solutions of the substrates (haloaromatics 1 ml, phenyl boronic acid 1.2 ml) and reagents (ligands and metal precursors, c=0.025 mol 1-1) were then added and brought up to room temperature with stirring.

At the end of the reaction time aliquot samples were taken, an internal standard (dodecane) added, dilution carried out with diethyl ether and analysis performed by gas chromatography. In each case biphenyl was indicated as a by-product.

Library 1: solvent THF; 1.2 mmol base; 1 mmol 4-chlorobenzonitrile; 1.2 mmol phenyl boronic acid; 1% metal (precursor); 1 equivalent (relative to the metal) ligand.

Library 2: solvent THF; 1.2 mmol base, 1 mmol 4-chloroanisol; 1.2 mmol phenyl boronic acid; 1% metal (precursor); 1 equivalent (relative to the metal) ligand; 60° C.; 24 hours.

Library 3: solvent 1,4-dioxan; 1.2 mmol base; 1 mmol 3-chloropyridine; 1.2 mmol phenyl boronic acid; 1% metal (precursor); 1 equivalent (relative to the metal) ligand; 60° C.; 24 hours

TABLE 5
Overview of the results of the following reaction:
Library 1: 4-chlorobenzonitrile + phenyl boronic acid → 4-cyanobiphenyl.
The results are arranged in order of yield.

| No. | Base | Ligand | Metal | Product yield |
|---|---|---|---|---|
| 01 | K₂CO₃ | B4MPm | Pd₂(dba)₃ | 100 |
| 02 | NaOtBu | BPyPy | Pd₂(dba)₃ | 100 |
| 03 | NaOtBu | B4MPm | Pd₂(dba)₃ | 100 |
| 04 | K₂CO₃ | BPyPy | Pd₂(dba)₃ | 83 |
| 05 | K₂CO₃ | TtBP | Pd₂(dba)₃ | 80 |
| 06 | K₃PO₄ | BPy₂(o-P)Py | Pd(OAc)₂ | 78 |
| 07 | NaOtBu | DtBPCl | Pd₂(dba)₃ | 76 |
| 08 | K₃PO₄ | PPmPm | Ni(cod)₂ | 65 |
| 09 | K₂CO₃ | C4MSi | Pd₂(dba)₃ | 60 |
| 10 | K₃PO₄ | TtBP | Pd₂(dba)₃ | 59 |
| 11 | K₂CO₃ | CPmSi | Pd₂(dba)₃ | 58 |
| 12 | K₃PO₄ | CPy₂(o-P)Py | Ni(cod)₂ | 52 |
| 13 | K₂CO₃ | DtBPCl | Pd₂(dba)₃ | 48 |
| 14 | K₃PO₄ | CPyPy | Pd₂(dba)₃ | 46 |
| 15 | Na₂CO₃ | TtBP | Pd₂(dba)₃ | 43 |
| 16 | K₃PO₄ | CPmPm | Ni(cod)₂ | 42 |
| 17 | K₃PO₄ | CPyPy | NiBr₂(dme) | 35 |
| 18 | K₃PO₄ | CPy₂(o-P)Py | Pd(OAc)₂ | 32 |
| 19 | Na₂CO₃ | CPyPy | Pd₂(dba)₃ | 29 |
| 20 | NaOtBu | BPmSi | Pd₂(dba)₃ | 28 |
| 21 | K₂CO₃ | CPaSi | Pd₂(dba)₃ | 27 |
| 22 | K₃PO₄ | BPmPm | Pd(OAc)₂ | 23 |
| 23 | K₃PO₄ | TtBP | Ni(cod)₂ | 21 |
| 24 | Na₂CO₃ | CPyPy | NiBr₂(dme) | 21 |
| 25 | K₂CO₃ | BPmSi | Pd₂(dba)₃ | 21 |
| 26 | K₂CO₃ | PPmSi | Ni(cod)₂ | 19 |
| 27 | K₃PO₄ | PPy₂(o-P)Py | Ni(cod)₂ | 19 |
| 28 | NaOtBu | BPaSi | Pd₂(dba)₃ | 19 |
| 29 | NaOtBu | B4MPm (0.5%) | Pd₂(dba)₃ | 16 |
| 30 | K₂CO₃ | BPaSi | Pd₂(dba)₃ | 15 |
| 31 | NaOtBu | CPmSi | Pd₂(dba)₃ | 13 |
| 32 | K₃PO₄ | BPy₂(o-P)Py | Ni(cod)₂ | 13 |
| 33 | Na₂CO₃ | TtBP | NiBr₂(dme) | 11 |
| 34 | K₃PO₄ | — | Ni(cod)₂ | 10 |
| 35 | NaOtBu | B4MPm (0.5%) | Pd₂(dba)₃ | 10 |
| 36 | K₂CO₃ | PaSiP | Ni(cod)₂ | 10 |
| 37 | NaOtBu | BPyPy (0.5%) | Pd₂(dba)₃ | 9 |
| 38 | K₃PO₄ | CPmPm | Pd(OAc)₂ | 8 |
| 39 | K₂CO₃ | B4MPm (0.5%) | Pd₂(dba)₃ | 6 |
| 40 | K₂CO₃ | BPyPy (0.5%) | Pd₂(dba)₃ | 4 |
| 41 | K₃PO₄ | PPy₂(o-P)Py | Pd(OAc)₂ | 4 |
| 42 | NaOtBu | CPmSi (0.5%) | Pd₂(dba)₃ | 3 |
| 43 | K₂CO₃ | C4MSi | NiBr₂(dme) | 3 |
| 44 | K₂CO₃ | PPmSi | Pd₂(dba)₃ | 1 |
| 45 | K₃PO₄ | PPmPm | Pd(OAc)₂ | 1 |
| 46 | K₃PO₄ | BPmPm | Ni(cod)₂ | 1 |
| 47 | K₂CO₃ | PPaSi | Pd₂(dba)₃ | 1 |
| 48 | K₃PO₄ | TtBP | NiBr₂(dme) | 0 |
| 49 | Na₂CO₃ | CPyPy | Ni(cod)₂ | 0 |
| 50 | Na₂CO₃ | TtBP | Ni(cod)₂ | 0 |
| 51 | K₂CO₃ | TtBP | NiBr₂(dme) | 0 |
| 52 | K₂CO₃ | C4MSi | Ni(cod)₂ | 0 |
| 53 | K₂CO₃ | TtBP | Ni(cod)₂ | 0 |
| 54 | NaOtBu | PPmSi | Pd₂(dba)₃ | 0 |
| 55 | NaOtBu | PPaSi | Pd₂(dba)₃ | 0 |
| 56 | K₂CO₃ | BPmSi | Ni(cod)₂ | 0 |
| 57 | K₂CO₃ | CPmSi | Ni(cod)₂ | 0 |
| 58 | K₂CO₃ | BPaSi | Ni(cod)₂ | 0 |
| 59 | K₂CO₃ | CPaSi | Ni(cod)₂ | 0 |
| 60 | NaOtBu | CPaSi | Pd₂(dba)₃ | 0 |

TABLE 6
Overview of the results of the following reaction:
Library 2: 4-chloroanisol + phenyl boronic
acid → 4-methoxybiphenyl.
The results are arranged in order of yield.

| | | | | Product | By-product |
|---|---|---|---|---|---|
| No. | Base | Ligand | Metal | yield | yield |
| 01 | K₃PO₄ | C46MMx | Ni(cod)₂ | 53 | 14 |
| 02 | K₂CO₃ | BPmPm | Pd₂(dba)₃ | 53 | 6 |
| | | (1eq) | | | |
| 03 | Na₂CO₃ | PPh₃ | Ni(cod)₂ | 43 | 3 |
| 04 | K₃PO₄ | PPh₃ | Ni(cod)₂ | 38 | 12 |
| 05 | K₃PO₄ | BPmPm | Pd₂(dba)₃ | 37 | 0 |
| 06 | K₃PO₄ | C6MPy | Ni(cod)₂ | 35 | 14 |
| 07 | K₂CO₃ | B4MPm | Pd₂(dba)₃ | 35 | 0 |
| 08 | K₃PO₄ | C6M6M | Ni(cod)₂ | 32 | 6 |
| 09 | K₂CO₃ | C46MMx | Ni(cod)₂ | 31 | |
| 10 | K₃PO₄ | BPmSi | Ni(cod)₂ | 31 | 0 |
| 11 | Na₂CO₃ | C46MMx | Ni(cod)₂ | 29 | |
| 12 | K₂CO₃ | BPmSi | Pd₂(dba)₃ | 26 | 4 |
| 13 | K₃PO₄ | B4MPm | Pd₂(dba)₃ | 26 | |
| 14 | K₃PO₄ | P6M6M | Ni(cod)₂ | 24 | 16 |
| 15 | K₃PO₄ | P6ML | Ni(cod)₂ | 24 | 15 |
| 16 | K₃PO₄ | 46MMxP | Ni(cod)₂ | 24 | 15 |
| 17 | K₃PO₄ | BPmSi | Pd₂(dba)₃ | 19 | 3 |
| 18 | K₃PO₄ | P46ML | Ni(cod)₂ | 17 | 23 |
| 19 | K₃PO₄ | PPyH | Ni(cod)₂ | 17 | 12 |
| 20 | K₃PO₄ | C46MMx | Pd₂(dba)₃ | 14 | 3 |
| 21 | Na₂CO₃ | C46MMx | Pd₂(dba)₃ | 12 | |
| 22 | K₃PO₄ | P6MPy | Ni(cod)₂ | 11 | 16 |
| 23 | K₃PO₄ | C6M6M | Pd₂(dba)₃ | 11 | 3 |
| 24 | K₂CO₃ | C46MMx | Pd₂(dba)₃ | 11 | |
| 25 | K₃PO₄ | DtBPCl | Pd₂(dba)₃ | 11 | 5 |
| 26 | K₂CO₃ | DtBPCl | Pd₂(dba)₃ | 9 | 0 |
| 27 | K₃PO₄ | C6MPy | Pd₂(dba)₃ | 8 | 3 |
| 28 | K₂CO₃ | -4MPm | Pd₂(dba)₃ | 7 | 0 |
| 29 | K₃PO₄ | C3MPy | Pd₂(dba)₃ | 6 | 2 |
| 30 | K₂CO₃ | -PyPy | Pd₂(dba)₃ | 6 | 0 |
| 31 | K₃PO₄ | TtBP | Ni(cod)₂ | 6 | |
| 32 | K₃PO₄ | CPyPy | Pd₂(dba)₃ | 5 | 2 |
| 33 | K₃PO₄ | CPyPy | Pd(OAc)₂ | 5 | 0 |
| 34 | K₃PO₄ | P3MPy | Ni(cod)₂ | 4 | 28 |
| 35 | K₃PO₄ | CPyPy | Ni(cod)₂ | 4 | 10 |
| 36 | K₃PO₄ | C3MPy | Ni(cod)₂ | 4 | 16 |
| 37 | K₃PO₄ | TtBP | Pd₂(dba)₃ | 4 | |
| 38 | K₃PO₄ | DtBPCl | Ni(cod)₂ | 4 | 10 |
| 39 | K₃PO₄ | B4MPm | Ni(cod)₂ | 4 | 32 |
| 40 | Na₂CO₃ | CPyPy | Pd(OAc)₂ | 3 | 0 |
| 41 | K₃PO₄ | PPyPy | Ni(cod)₂ | 2 | 22 |
| 42 | K₃PO₄ | P6MPy | Pd₂(dba)₃ | 2 | 5 |
| 43 | K₃PO₄ | P46ML | Pd₂(dba)₃ | 2 | 6 |
| 44 | K₃PO₄ | PPyPy | Pd₂(dba)₃ | 1 | 4 |
| 45 | K₃PO₄ | P3MPy | Pd₂(dba)₃ | 1 | 4 |
| 46 | K₃PO₄ | P6M6M | Pd₂(dba)₃ | 1 | 6 |
| 47 | K₃PO₄ | P6ML | Pd₂(dba)₃ | 1 | 6 |
| 48 | K₃PO₄ | P46MMx | Pd₂(dba)₃ | 1 | 7 |
| 49 | K₃PO₄ | PPh₃ | Pd₂(dba)₃ | 1 | 6 |
| 50 | Na₂CO₃ | CPyPy | Pd₂(dba)₃ | 1 | 1 |
| 51 | K₃PO₄ | PPyH | Pd₂(dba)₃ | 0 | 6 |
| 52 | K₃PO₄ | CPyH | Pd₂(dba)₃ | 0 | 2 |
| 53 | K₃PO₄ | CPyH | Ni(cod)₂ | 0 | 0 |
| 54 | Na₂CO₃ | CPyPy | Ni(cod)₂ | 0 | 8 |
| 55 | Na₂CO₃ | CPyPy | CoCl₂ | 0 | 0 |
| 56 | Na₂CO₃ | CPyPy | FeCl₂ | 0 | 0 |
| 57 | Na₂CO₃ | CPyPy | CuCl(cod) | 0 | 0 |
| 58 | Na₂CO₃ | PPh₃ | Pd₂(dba)₃ | 0 | 23 |
| 59 | K₃PO₄ | CPyPy | CoCl₂ | 0 | 0 |
| 60 | K₃PO₄ | CPyPy | FeCl₂ | 0 | 0 |
| 61 | K₃PO₄ | CPyPy | CuCl(cod) | 0 | 0 |
| 62 | K₂CO₃ | CPmSi | Pd₂(dba)₃ | 0 | 0 |
| 63 | K₂CO₃ | -PyPy | Ni(cod)₂ | 0 | 0 |
| 64 | K₂CO₃ | B4MPm | Ni(cod)₂ | 0 | 0 |
| 65 | K₂CO₃ | DtBPCl | Ni(cod)₂ | 0 | 0 |
| 66 | K₂CO₃ | BPmPm | Ni(cod)₂ | 0 | 0 |
| | | (1eq) | | | |
| 67 | K₂CO₃ | BPmSi | Ni(cod)₂ | 0 | 0 |
| 68 | K₂CO₃ | CPmSi | Ni(cod)₂ | 0 | 0 |
| 69 | K₂CO₃ | -PyPy | Pd₂(dba)₃ | 0 | 0 |
| 70 | K₂CO₃ | -PmPm | Pd₂(dba)₃ | 0 | 0 |
| | | (1eq) | | | |
| 71 | K₂CO₃ | -PmSi | Pd₂(dba)₃ | 0 | 0 |
| 72 | K₂CO₃ | CPmSi | Pd₂(dba)₃ | 0 | 0 |
| 73 | K₂CO₃ | TtBP | Pd₂(dba)₃ | 0 | 13 |
| 74 | K₂CO₃ | -PyPy | Ni(cod)₂ | 0 | 0 |
| 75 | K₂CO₃ | -4MPm | Ni(cod)₂ | 0 | 0 |
| 76 | K₂CO₃ | BPmPm | Ni(cod)₂ | 0 | 0 |
| | | (1eq) | | | |
| 77 | K₂CO₃ | -PmSi | Ni(cod)₂ | 0 | 0 |
| 78 | K₂CO₃ | CPmSi | Ni(cod)₂ | 0 | 0 |
| 79 | K₂CO₃ | TtBP | Ni(cod)₂ | 0 | 0 |
| 80 | K₃PO₄ | -PmSi | Pd₂(dba)₃ | 0 | |
| 81 | K₃PO₄ | -4MPm | Pd₂(dba)₃ | 0 | |
| 82 | K₃PO₄ | BPmPm | Ni(cod)₂ | 0 | 0 |
| 83 | K₃PO₄ | -PmSi | Ni(cod)₂ | 0 | 0 |
| 84 | K₃PO₄ | -4MPm | Ni(cod)₂ | 0 | 0 |

TABLE 7
Overview of the results of the following reaction:
Library 3: 3-chloropyridine + phenyl
boronic acid → 3-phenylpyridine.
The results are arranged in order of yield.

| | | | | | By- |
|---|---|---|---|---|---|
| | | | | Product | product |
| No. | Base | Ligand | Metal | yield | yield |
| 1 | K₃PO₄ | B4MPm | Pd(OAc)₂ | 90 | 43 |
| 2 | K₃PO₄ | B4MPm | Pd₂(dba)₃ | 89 | 36 |
| 3 | K₃PO₄ | B4MPm (1%) | Pd₂(dba)₃ (1%) | 88 | 31 |
| 4 | K₃PO₄ | BPyPy | Pd₂(dba)₃ | 86 | 58 |
| 5 | K₃PO₄ | BPaPa | Pd₂(dba)₃ | 79 | 34 |
| 6 | K₃PO₄ | B4MPm (0.5%) | Pd₂(dba)₃ (0.5%) | 76 | 21 |
| 7 | K₂CO₃ | B4MPm | Pd(OAc)₂ | 74 | 24 |
| 8 | K₃PO₄ | B4MPm (0.25%) | Pd₂(dba)₃ | 69 | 10 |
| | | | (0.25%) | | |
| 9 | K₂CO₃ | BPyPy | Pd₂(dba)₃ | 58 | 37 |
| 10 | K₂CO₃ | BPyPy | PdCl₂(cod) | 52 | 10 |
| 11 | K₂CO₃ | B4MPm | PdCl₂(cod) | 51 | 11 |
| 12 | K₃PO₄ | BPyPy | PdCl₂(cod) | 42 | 15 |
| 13 | K₂CO₃ | B4MPm | Pd₂(dba)₃ | 39 | 8 |
| 14 | K₃PO₄ | B4MPm | PdCl₂(cod) | 37 | 8 |
| 15 | K₃PO₄ | BPmSi | Ni(cod)₂ | 35 | 16 |
| 16 | K₃PO₄ | BPmSi | Pd₂(dba)₃ | 32 | 19 |
| 17 | K₃PO₄ | BPaPa | PdCl₂(cod) | 31 | 10 |
| 18 | K₂CO₃ | B4MPm | Ni(cod)₂ | 27 | 35 |
| 19 | K₃PO₄ | CPyPy | Ni(cod)₂ | 25 | 33 |
| 20 | K₂CO₃ | DtBPCl | Pd₂(dba)₃ | 20 | 18 |
| 21 | K₃PO₄ | PPyPy | Ni(cod)₂ | 18 | 14 |
| 22 | K₂CO₃ | B4MPm (0.5%) | Ni(cod)₂ (0.5%) | 16 | 31 |
| 23 | K₂CO₃ | PPyPy | Ni(cod)₂ | 10 | 18 |
| 24 | K₂CO₃ | CPyPy | Ni(cod)₂ | 9 | 17 |
| 25 | K₃PO₄ | B4MPm | Ni(cod)₂ | 8 | 11 |
| 26 | K₃PO₄ | C4MPm | Ni(cod)₂ | 7 | 7 |
| 27 | K₃PO₄ | BPyPy | Ni(cod)₂ | 6 | 16 |
| 28 | K₃PO₄ | TtBP | Pd₂(dba)₃ | 5 | 34 |
| 29 | K₂CO₃ | TtBP | Pd₂(dba)₃ | 5 | 38 |
| 30 | K₃PO₄ | BPaPa | Ni(cod)₂ | 5 | 16 |
| 31 | K₃PO₄ | BPaPa | Pd(OAc)₂ | 4 | 1 |
| 32 | K₃PO₄ | C4MPm | Pd₂(dba)₃ | 3 | 9 |
| 33 | K₃PO₄ | rac. BINAP | Pd₂(dba)₃ | 1 | 6 |
| 34 | K₂CO₃ | C4MPm | Pd₂(dba)₃ | 1 | 1 |
| 35 | K₃PO₄ | BDPP | Pd₂(dba)₃ | 0 | 4 |
| 36 | K₂CO₃ | rac. BINAP | Pd₂(dba)₃ | 0 | 7 |
| 37 | K₂CO₃ | BDPP | Pd₂(dba)₃ | 0 | 13 |
| 38 | K₃PO₄ | PPyPy | Pd₂(dba)₃ | 0 | 2 |
| 39 | K₃PO₄ | CPyPy | Pd₂(dba)₃ | 0 | 1 |
| 40 | K₂CO₃ | PPyPy | Pd₂(dba)₃ | 0 | 5 |
| 41 | K₂CO₃ | CPyPy | Pd₂(dba)₃ | 0 | 2 |
| 42 | K₂CO₃ | -4MPm | Pd₂(dba)₃ | 0 | 3 |
| 43 | K₂CO₃ | BPyPy | Ni(cod)₂ | 0 | 4 |
| 44 | K₂CO₃ | C4MPm | Ni(cod)₂ | 0 | 2 |
| 45 | K₃PO₄ | C4MPm | Pd(OAc)₂ | 0 | 4 |
| 46 | K₂CO₃ | C4MPm | Pd(OAc)₂ | 0 | 1 |
| 47 | K₃PO₄ | BPyPy | Pd(OAc)₂ | 0 | 2 |
| 48 | K₂CO₃ | BPyPy | Pd(OAc)₂ | 0 | 2 |

### Example 4

### Grignard Couplings

The experiments were performed in the same way as the Suzuki reactions described, in a parallel reactor. Unless otherwise stated, the reaction temperature was 60° C. and the reaction time 24 hours. The solvent in all cases is THF. The molar ratios of the reaction partners were:

Substrate: 1 mmol (1M solvent).

Reagent (phenyl magnesium bromide): 1.2 mmol (1M solution).

Ligands: 0.01 mmol (0.02 mmol for monodentate ligands), unless otherwise stated, 0.4 ml (0.025M solution).

Metal precursors: 0.01 mmol, (0.025M solution).

At the end of the 24 hours the Schlenk flasks were allowed to cool and 0.5 ml methanol added to each to annihilate excess reagent. The yields were then determined by GC.

a) Cross-Coupling: 2-chloro-m-xylene+Phenyl Magnesium Bromide

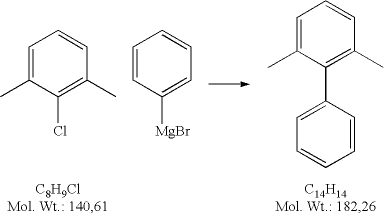

TABLE 8
Results for a)

| No. | Metal | Ligand | T/° C. | Product yield |
|---|---|---|---|---|
| 01 | Ni(0) | B4MPm | 60 | 68 |
| 02 | Ni(0) | B4MPm | 60 | 63 |
| 03 | Ni(0) | BPmPm | 60 | 51 |
| 04 | Ni(0) | B4M4M | 60 | 48 |
| 05 | Ni(0) | DtBPCl | 60 | 29 |
| 06 | Ni(0) | TtBP (4eq) | 60 | 17 |
| 07 | Ni(0) | TtBP (3eq) | 60 | 12 |
| 08 | Ni(0) | TtBP (2eq) | 60 | 10 |
| 09 | Ni(0) | PCy3 | 60 | 10 |
| 10 | Ni(0) | B4MPm | RT | 7 |
| 11 | Pd(0) | TtBP (3eq) | 60 | 4 |
| 12 | Ni(0) | C12PmPm | 60 | 4 |
| 13 | Ni(0) | — | 60 | 4 |
| 14 | Pd(0) | TtBP (2eq) | 60 | 3 |
| 15 | Pd(0) | TtBP (4eq) | 60 | 3 |
| 16 | Ni(0) | BPmPm | RT | 3 |
| 17 | NiCl2 5% | — | 60 | 3 |
| 18 | Ni(CO)2(PPh3)2 | — | 60 | 2 |
| 19 | Ni(0) | PPh3 | 60 | 1 |
| 20 | Ni(0) | DtBPCl | RT | 1 |
| 21 | Pd(0) | DtBPCl | 60 | 0 |
| 22 | CoCl2 | — | 60 | 0 |
| 23 | Ni(0) | TtBP | RT | 0 |
| 24 | — | — | RT | 0 |
| 25 | — | — | 60 | 0 |

b) Cross-Coupling: 2-chlorotoluene+Phenyl Magnesium Bromide

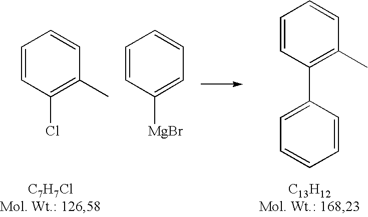

TABLE 9
Results for b)

| No. | Metal | Ligand | Product yield |
|---|---|---|---|
| 01 | Ni(0) | B4MPm | 88 |
| 02 | Ni(0) | C12-4MPm | 75 |
| 03 | Ni(0) | PCy3 | 65 |
| 04 | Ni(0) | DtBPCl | 58 |
| 05 | Ni(0) | TtBP | 55 |
| 06 | Ni(0) | PPh3 | 53 |
| 07 | Ni(0) | — | 51 |
| 08 | Ni(0) | C12-4M4M | 51 |
| 09 | Ni(0) | C12-PmPm | 45 |
| 10 | Ni(0) | C12-PmPm | 43 |
| 11 | Ni(0) | BPmPm | 39 |
| 12 | NiCl2 5% | — | 31 |
| 13 | Pd(0) | TtBP (3eq) | 7 |
| 14 | Pd(0) | TtBP (2eq) | 6 |
| 15 | Pd(0) | TtBP (4eq) | 4 |
| 16 | CoCl2 | C12-4M4M | 3 |
| 17 | CoCl2 | C12-4MPm | 2 |
| 18 | Pd(0) | B4MPm | 2 |
| 19 | CoCl2 | — | 2 |
| 20 | CoCl2 | C12-PmPm | 1 |
| 21 | Pd(0) | DtBPCl | 0 |

c) Cross-Coupling: 2-CIPy+PhMgBr

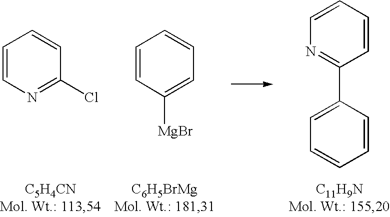

TABLE 10
Results for c)

| No. | Metal | Ligand | Product yield |
|---|---|---|---|
| 01 | Pd(0) | B4MPm | 100 |
| 02 | Pd(0) | BPmPm | 97 |
| 03 | Pd(0) | PCy3 | 77 |
| 04 | Ni(0) | TtBP | 73 |
| 05 | Pd(0) | TtBP | 69 |
| 06 | — | — | 31 |

d) Cross-Coupling: 4-ClAn+Phenyl Magnesium Bromide

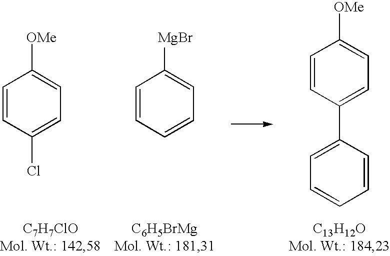

| No. | Metal | Ligand | Product yield |
|---|---|---|---|
| 01 | Ni(0) | PCy3 | 100 |
| 02 | Ni(0) | TtBP | 100 |
| 03 | Ni(0) | BPmSi | 100 |
| 04 | Ni(0) | CPmSi | 100 |
| 05 | Ni(0) | BPyPy | 100 |
| 06 | Ni(0) | CPyPy | 100 |
| 07 | Ni(0) | — | 100 |
| 08 | Ni(0) | CAPe | 100 |
| 09 | Ni(0) | B4MPm | 100 |
| 10 | Ni(0) | C4M4M | 99 |
| 11 | Ni(0) | BPmPm | 99 |
| 12 | Ni(0) | CPicSi | 98 |
| 13 | Ni(0) | BPaPa | 97 |
| 14 | Ni(0) | PPmSi | 97 |
| 15 | Ni(0) | PPicSi | 96 |
| 16 | Ni(0) | P4M4M | 96 |
| 17 | Ni(0) | B4M4M | 94 |
| 18 | Ni(0) | -4M4M | 89 |
| 19 | Ni(0) | PPyPy | 84 |
| 20 | Ni(2) | B4MPm | 82 |
| 21 | Ni(0) | BPicSi | 78 |
| 22 | Ni(CO)2(PPh3)2 | — | 61 |
| 23 | Pd(0) | B4M4M | 51 |
| 24 | Ni(2) | — | 50 |
| 25 | Ni(2) | PCy3 | 33 |
| 26 | Li2CuCl4 5% | — | 18 |
| 27 | Pd(0) | BPmPm | 14 |
| 28 | PdAc | PPicSi | 12 |
| 29 | Pd(0) | —4M4M | 10 |
| 30 | Pd(0) | C4M4M | 9 |
| 31 | Pd(0) | TtBP | 8 |
| 32 | PdAc | BPicSi | 7 |
| 33 | Pd(0) | B4MPm | 7 |
| 34 | PdAc | — | 6 |
| 35 | NiCl2 5% | — | 2 |
| 36 | — | — | 0 |

e) Cross-Coupling: 3-CIPy+PhMgBr

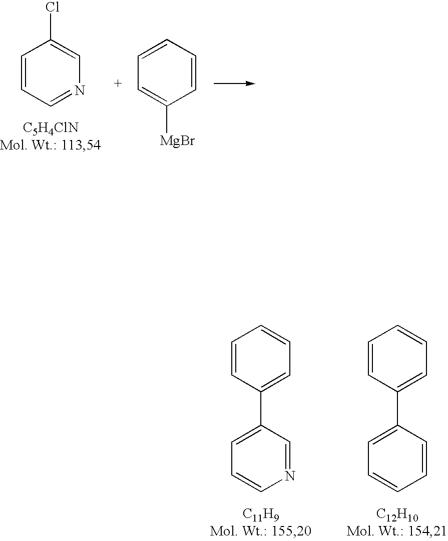

TABLE 11
Results for e)

| No. | Metal | Ligand | Product yield |
|---|---|---|---|
| 01 | Ni(0) | BPmPm | 100 |
| 02 | Ni(0) | B4MPm | 96 |
| 03 | Ni(0) | B4M4M | 78 |
| 04 | Ni(0) | P4M4M | 72 |
| 05 | Pd(0) | TtBP | 72 |
| 06 | Ni(0) | C12PmPm 2eq | 68 |
| 07 | NiCl2 | DCMA (6eq) | 67 |
| 08 | Pd(0) | C12PmPm 2eq | 61 |
| 09 | Ni(0) | C4M4M | 60 |
| 10 | Ni(0) | CAPe | 59 |
| 11 | Pd(0) | CAPe | 55 |
| 12 | Pd(0) | P4M4M | 50 |
| 13 | PdAc | DCMA (6eq) | 49 |
| 14 | Ni(0) | DtBPCl | 48 |
| 15 | Pd(0) | B4M4M | 45 |
| 16 | Ni(0) | TtBP | 43 |
| 17 | Ni(0) | -4M4M | 43 |
| 18 | Ni(0) | PCy3 | 41 |
| 19 | Pd(0) | C4M4M | 40 |
| 20 | Li2CuCl4 5% | — | 35 |
| 21 | Pd(0) | PCy3 | 25 |
| 22 | — | — | 21 |

1-27. (canceled)

28. A P-functionalised amine of a nitrogen-containing aromatic having the general formula:
R¹(R²)P—N(R′)R″ (I)
wherein:
R¹ and R² independently stand for a radical selected from the group consisting of: a saturated or unsaturated, branched or unbranched C₁-C₂₄ alkyl; a saturated or unsaturated, branched or unbranched C₃-C₈ cycloalkyl; and an aromatic radical having 5 to 14 C-atoms, wherein one or more of said C atoms may optionally be substituted by a heteroatom selected from the group consisting of: N, O and S;
and wherein said radical can itself be mono- or polysubstituted by one or more radicals selected from the group consisting of: hydrogen; a C₁-C₂₀ alkyl; a C₂-C₂₀ alkenyl; a C₁-C₁₀ haloalkyl; a C₃-C₈ cycloalkyl; a C₂-C₉ heteroalkyl; an aromatic radical having 6 to 10 C atoms, wherein one or more of the aromatic C atoms may optionally be substituted by a heteroatom selected from the group consisting of: N, O and S; a C₁-C₁₀ alkoxy; a C₁-C₉ trihalomethylalkyl; halo; nitro; hydroxy; trifluoromethyl sulfonato; oxo; amino; a C₁-C₈ substituted amino selected from the group consisting of: NH-alkyl-C₁-C₈; NH-aryl-C₅-C₆; N-alkyl₂-C₁-C₈; N-aryl₂-C₅-C₆; N-alkyl₃-C₁-C₈⁺; N-aryl₃-C₅-C₆⁺; NH—CO-alkyl-C₁-C₈; NH—CO-aryl-C₅-C₆; cyano; a carboxylato in the form of either COOH or COOQ, wherein Q represents either a monovalent cation or C₁-C₈ alkyl; C₁-C₆ acyloxy; sulfonato, wherein said sulfonato selected from SO₃H and SO₃Q, wherein Q in said sulfonato represents either a monovalent cation, a C₁-C₈ alkyl or a C₆ aryl; a phosphato selected from PO₃H₂, PO₃HQ and PO₃Q₂, wherein Q in said phosphato represents a monovalent cation, a C₁-C₈ alkyl or C₆ aryl; or a tri-C₁-C₆ alkyl silyl;
and wherein R¹ and R² can also be bridged together,
wherein:
R′ stands for an aromatic radical containing at least one N atom and having 4 to 13 C atoms, which is bound to the nitrogen atom according to formula I in the 2-position relative to the at least one aromatic N atom, and wherein one or more of the aromatic C atoms may optionally be substituted by an additional heteroatom selected from the group consisting of: N, O and S;
wherein:
R″ stands for trimethylsilyl or for an aromatic radical having 5 to 14 C atoms, and wherein one or more of said C atoms may optionally be substituted by a heteroatom selected from the group consisting of: N, O and S;
and wherein:
the radicals listed for R′ and R″ may optionally have at least one substituent in addition to hydrogen atoms, said substituent being selected from the group consisting of: a C₁-C₈alkyl; an O-alkyl(C₁-C₈); OH; OCO-alkyl(C₁-C₈); O-phenyl; phenyl; aryl; fluorine; NO₂; Si-alkyl(C₁-C₈)₃; CN; COOH; CHO; SO₃H; NH₂; NH-alkyl(C₁-C₈); N-alkyl(C₁-C₈)₂; NH-aryl, N-aryl₂; P(alkyl(C₁-C₈))₂; P(aryl)₂; SO₂-alkyl(C₁-C₆); SO-alkyl(C₁-C₆); CF₃; NHCO-alkyl(C₁-C₄); COO-alkyl(C₁-C₈); CONH₂; CO-alkyl(C₁-C₈); NHCHO; NHCOO-alkyl(C₁-C₄); CO-phenyl; COO-phenyl; CH═CH—CO₂-alkyl(C₁₋C₈), CH═CHCOOH; PO(phenyl)₂; PO(alkyl(C₁-C₄))₂; PO₃H₂; PO(O-alkyl(C₁-C₆))₂; SO₃(alkyl(C₁-C₄));
wherein aryl represents an aromatic having 5 to 14 ring-carbon atoms, wherein one or more ring-carbon atoms can be replaced by nitrogen, oxygen and/or sulfur atoms and the alkyl radicals can be branched, unbranched and/or cyclic, saturated or unsaturated.

29. The P-functionalised amine of claim 1, wherein R¹ and R² are a radical independently selected from the group consisting of: phenyl; cyclohexyl; alkyl; 2-alkylphenyl; 3-alkylphenyl; 4-alkylphenyl; 2,6-dialkylphenyl; 3,5-dialkylphenyl; 3,4,5-trialkylphenyl; 2-alkoxyphenyl; 3-alkoxyphenyl; 4-alkoxyphenyl; 2,6-dialkoxyphenyl; 3,5-dialkoxyphenyl; 3,4,5-trialkoxyphenyl; 3,5-dialkyl-4-alkoxyphenyl; 4-dialkylamino; 3,5-trifluoromethyl; 4-trifluoromethyl; 2-sulfonyl; 3-sulfonyl; and 4-sulfonyl;
and wherein said alkyl and alkoxy groups each independently contain 1 to 6 carbon atoms.

30. The P-functionalised amine of claim 1, wherein R¹ and R² are independently a radical selected from the group consisting of: phenyl; tert-butyl; and cyclohexyl.

31. The P-functionalised amine of claim 1, wherein the radicals R¹ and R² are identical.

32. The P-functionalised amine of claim 1, wherein R′ is a radical selected from the group consisting of: 3-methylpyridyl; 4-methylpyridyl; 6-methylpyridyl; 4,6-dimethylpyridyl; 6-methoxypyridyl; pyridyl; pyrimidyl; pyrazinyl; 4-methyl quinolinyl or Py₂(o-P);
and wherein R′ is bound in the 2-position to the N atom according to formula I.

33. The P-functionalised amine of claim 1, wherein R″ is a radical selected from the group consisting of: 3-methylpyridyl; 4-methylpyridyl; 6-methylpyridyl; 4,6-dimethylpyridyl; 6-methoxypyridyl; pyridyl; pyrimidyl; pyrazinyl; 4-methyl quinolinyl; Py₂(o-P); phenyl; naphthyl; fluorenyl; and trimethylsilyl;
and wherein the N-containing aromatic radicals are bound in the 2-position to the N atom according to formula I.

34. The P-functionalised amine of claim 1, wherein the N-containing aromatic radical having 4 to 13 C atoms is selected from the group consisting of: pyrimid-2-yl; 2-pyridyl; pyrazin-2-yl; and quinolin-2-yl.

35. The P-functionalised amine of claim 1, wherein the substituents for R′ and R″ are a radical selected from the group consisting of: C₁-C₈-alkyl; O-alkyl(C₁-C₈); OH; OCO-alkyl(C₁-C₈); O-phenyl; phenyl; aryl, fluorine; Si-alkyl(C₁-C₈)₃; CN; COOH; SO₃H; SO₂-alkyl(C₁-C₆); SO-alkyl(C₁-C₆); CF₃; COO-alkyl(C₁-C₈); CO-alkyl(C₁-C₈); CO-phenyl; COO-phenyl; and SO₃(alkyl(C₁-C₄)).

36. The P-functionalised amine of claim 1, wherein the substituents for R¹, R², R′ and R″ are radicals independently selected from the group consisting of: C₁-C₆ alkyl; O—C₁-C₆ alkyl; and OH.

37. A process for the production of the P-functionalised amine of claim 1, comprising reacting a compound having the formula NHR′R″ in the presence of a strong base with a compound having the formula R¹(R²)PHal;
wherein R¹, R², R′ and R″ are as defined in claim 1 and Hal stands for chlorine or bromine.

38. The process according of claim 37, wherein the strong base is an organometallic reagent.

39. A transition-metal coordination compound, comprising:
a) at least one ligand, wherein said ligand is a P-functionalised amine according to claim 1; and
b) at least one transition metal from subgroup VIII of the periodic table.

40. The transition-metal coordination compound of claim 39, wherein said transition metal is selected from the group consisting of: palladium; nickel; platinum; rhodium; iridium; ruthenium; and cobalt.

41. The transition-metal coordination compound of claim 39, wherein said transition metal is palladium or nickel.

42. The transition-metal coordination compound of claim 39, wherein said transition metal is part of a five-membered ring.

43. A process for the production of the transition-metal coordination compound of claim 39, comprising reacting a ligand with a complex and/or a salt of a transition metal from subgroup VIII of the periodic table, wherein said ligand is a P-functionalised amine according to claim 1.

44. A method of catalyzing a chemical reaction, comprising reacting compounds in the presence of a catalyst, wherein said catalyst is a P-functionalised amine according to claim 1 in combination with a transition metal complex or a transition metal salt, and wherein said transition metal is from subgroup VIII of the periodic table of elements.

45. A method of catalyzing a chemical reaction, comprising reacting compounds in the presence of a catalyst, wherein said catalyst is a transition-metal coordination compound complex according to claim 39.

46. The method of either claim 44 or claim 45, wherein said chemical reaction is the production of dienes or arylated olefins (Heck reactions), biaryls (Suzuki reactions), α-aryl ketones and/or amines from aryl halides or vinyl halides.

47. The method of either claim 44 or claim 45, wherein said chemical reaction is selected from: carbonylation of aryl halides, alkynylation with alkynes (Sonogashira couplings) or cross-couplings with organometallic reagents.

48. The method of either claim 44 or claim 45, wherein said chemical reaction is the production of aryl olefins, dienes, diaryls, benzoic acid derivatives, acrylic acid derivatives, aryl alkanes, alkynes or amines.

49. The method of either claim 44 or claim 45, wherein said chemical reaction is performed at temperatures from 0 to 200° C.

50. The method of either claim 44 or claim 45, wherein said ligand is used in excess relative to said transition metal in the ratio of transition metal to ligand of 1:1 to 1:1000.

51. The method of either claim 44 or claim 45, wherein the ratio of transition metal to ligand is 1:1 to 1:100.

52. The method of either claim 44 or claim 45, wherein the transition metal concentration in said chemical reaction is between 5 mol % and 0.001 mol %.

53. The method of either claim 52, wherein said the transition metal concentration is between 1 mol % and 0.01 mol %.

54. An amine selected from the group consisting of: N-(4-methylpyrid-2-yl)-N-(pyrimid-2-yl) amine; N-(4,6-dimethylpyrid-2-yl)-N-(6-methoxypyrid-2-yl) amine; N,N-bis(pyrazinyl) amine; and N,N,N′-tris(pyrid-2-yl)-o-phenylene diamine.
